(19) United States
(12) Patent Application Publication
(10) Pub. No.: US 2009/0018705 A1
(43) Pub. Date: Jan. 15, 2009

(54) DEMAND CONTROL DEVICE

(75) Inventors: Atsushi Ouchi, Osaka (JP); Hideki Nakajima, Osaka (JP)

Correspondence Address: MOTS LAW, PLLC, 1001 PENNSYLVANIA AVE. N.W., SOUTH, SUITE 600, WASHINGTON, DC, 20004, US

(73) Assignee: Sanyo Electric Co., Ltd., Moriguchi City (JP)

(21) Appl. No.: 12/280,580

(22) PCT Filed: Feb. 27, 2007
(86) PCT No.: PCT/JP2007/054149

§ 371 Date: Aug. 25, 2008

(30) Foreign Application Priority Data
Feb. 28, 2006 (JP) 2006-051535

(51) Int. Cl. G06F 1/32

(52) U.S. Cl. 700/291

(57) ABSTRACT

A demand control device includes a storing unit (21) arranged to store performance data of a power consumption accumulated value by environmental condition in a power database (24), and a predicted value calculating unit (21) arranged to, at a start of a demand time period, calculate a predicted value of the power consumption accumulated value for the demand time period based on the performance data stored in the power database (24). Each of the environmental conditions is specified by a time zone and an environmental condition other than the time zone. The predicted value calculating unit (21) extracts the performance data that the time zone corresponds to this demand time period and that the environmental condition other than the time zone coincides with the current environmental condition, from the power database (24) and then calculates the predicted value of the power consumption accumulated value for this demand time period based on the performance data thus extracted.

### BACKGROUND OF THE INVENTION

1. Field of the Invention

The present invention relates to a demand control device capable of predicting a power consumption accumulated value for a demand time period and controlling appliances based on a predicted value.

2. Description of Related Art

A demand-based contract is available as a type of electricity rate contract signed between an owner of a store or a facility and an electric power supplier. The demand-based contract determines electricity rates based on the maximum accumulated value of electric power consumed for a demand time period in a year. In this system, a power consumption accumulated value is calculated for each of the predetermined demand time periods, and the electricity rates are determined based on the maximum value of those calculated for the respective demand time periods in a year. The demand time period is a period of time such as values of 15 minutes or 30 minutes, or a time zone between 12:00 and 2:00 in which electric power consumption increases. Therefore, it is necessary to minimize the power consumption accumulated value for one demand time period.

Hence, during a demand time period, a power consumption accumulated value from a start of the demand time period to the end thereof is predicted, and when the predicted value exceeds the predetermined contracted power amount, a control (demand control) to stop the operation of a certain appliance is performed. The power consumption accumulated value from the start of the demand time period to the end thereof is conventionally predicted based on a linear prediction technique.

Accordingly, the power consumption accumulated value from the start of the demand time period to the end thereof can be predicted by the following formula (1):

R=P+(Δp/Δt)×Tn (1)

R: Predicted power consumption accumulated value from the start of the demand time period to the end of the demand time period

P: Power consumption accumulated value from the start of the demand time period up to the current moment

Δp: Electric power consumption during a sampling period

Δt: Sampling period

Tn: Remaining period of demand time period (period of time from the current moment to the end of the demand time period)

However, with this technique, variation of the Δp/Δt values can lead to significant variation of the predicted values R. Such variation may be remarkable with large Tn values. Therefore, with the conventional technique, the operation of appliances is unnecessarily stopped, which may deteriorate environment such as ambient temperature in the store or the facility, or the timing of stopping the operation of appliances is delayed, which may cause the power consumption accumulated value to exceed the contracted power amount.

On the other hand, in the invention described in Japanese Unexamined Patent Publication No. 2002-27668, changes of the consumed electric power amount for a demand time period are previously registered in a database, the past data approximate to the changes of the consumed electric power amount from the start of the demand time period up to the current moment is extracted from the database for each sampling period, and future changes of the consumed electric power amount are predicted from the extracted data. Although this technique can reduce variation of the predicted values, the compared target is only the changes of the consumed electric power amount from the start of the demand time period up to the current moment, which does not ensure the approximation between changes of the predicted consumed electric power amount from the current moment onwards and changes of the actual consumed electric power amount from the current moment onwards. Therefore, abrupt variations in the electric power consumption may delay the timing of stopping the operation of the appliance, so that the power consumption accumulated value may exceed the contracted power amount.

An object of the present invention is to provide a demand control device capable of avoiding as possible that the actual power consumption accumulated value for a demand time period exceeds the contracted power amount.

### DISCLOSURE OF THE INVENTION

A first demand control device according to the present invention, in a demand control device applied in a facility provided with a plurality of power-consuming appliances, comprises a storing unit arranged to store performance data of a power consumption accumulated value by environmental condition in a power database; a predicted value calculating unit arranged to, at a start of a demand time period, calculate a predicted value of the power consumption accumulated value for the demand time period based on the performance data stored in the power database; and a control unit arranged to control an appliance based on the predicted value calculated by the predicted value calculating unit and a target value previously set, in which each of the environmental conditions is specified by a time zone and an environmental condition other than the time zone, and the predicted value calculating unit extracts the performance data that the time zone corresponds to this demand time period and that the environmental condition other than the time zone coincides with the current environmental condition, from the power database and then calculates the predicted value of the power consumption accumulated value for this demand time period based on the performance data thus extracted.

The control unit described above that may be used include, for example, a control unit arranged to, if the predicted value calculated by the predicted value calculating unit exceeds the target value, select an appliance to stop its operation based on a difference between the predicted value and the target value, and then stop the operation of the selected appliance.

A second demand control device according to the present invention, in a demand control device applied in a facility provided with a plurality of power-consuming appliances, comprises a storing unit arranged to store performance data of a power consumption accumulated value by environmental condition in a power database; a predicted value calculating unit arranged to, during a demand time period, calculate an actual power consumption accumulated value from a start of the demand time period up to the current moment, and at the same time, calculate a predicted value of the power consumption accumulated value from the current moment to an end of the demand time period based on the performance data stored in the power database and then add the actual power consumption accumulated value from the start of the demand time period up to the current moment to the predicted value of the power consumption accumulated value from the current moment to the end of the demand time period, thereby calculating a predicted value of the power consumption accumulated value for this demand time period: and a control unit arranged to control an appliance based on the predicted value calculated by the predicted value calculating unit and a target value previously set, in which each of the environmental conditions is specified by a time zone and an environmental condition other than the time zone, and the predicted value calculating unit comprises a unit arranged to calculate the actual power consumption accumulated value from the start of the demand time period up to the current moment; a unit arranged to extract the performance data that the time zone corresponds to a period from the current moment to the end of this demand time period and that the environmental condition other than the time zone coincides with the current environmental condition, from the power database and then calculate the predicted value of the power consumption accumulated value from the current moment to the end of the demand time period based on the performance data thus extracted; and a unit arranged to calculate the predicted value of the power consumption accumulated value for this demand time period by adding the actual power consumption accumulated value from the start of the demand time period up to the current moment to the predicted value of the power consumption accumulated value from the current moment to the end of the demand time period.

The control unit described above that may be used include, for example, a control unit arranged to, if the predicted value calculated by the predicted value calculating unit exceeds the target value, select an appliance to stop its operation based on a difference between the predicted value and the target value, and then stop the operation of the selected appliance.

The control unit described above that may be used include, for example, a control unit comprising a unit arranged to, if the predicted value calculated by the predicted value calculating unit exceeds the target value, select an appliance to be stopped based on a difference between the predicted value and the target value, and then stop the selected appliance; and a unit arranged to, if the predicted value calculated by the predicted value calculating unit is equal to or less than the target value, select an appliance to be reset based on the difference between the predicted value and the target value, and then reset the selected appliance.

A third demand control device according to the present invention, in a demand control device applied in a facility provided with a plurality of power-consuming appliances, comprises a storing unit arranged to store performance data of a power consumption accumulated value by environmental condition in a power database; a first predicted value calculating unit arranged to, at a start of a demand time period, calculate a predicted value of the power consumption accumulated value for this demand time period based on the performance data stored in the power database; a first control unit arranged to control an appliance based on the predicted value calculated by the first predicted value calculating unit and a target value previously set; a second predicted value calculating unit arranged to, during the demand time period, calculate an actual power consumption accumulated value from the start of the demand time period up to the current moment, and at the same time, calculate a predicted value of the power consumption accumulated value from the current moment to an end of the demand time period based on the performance data stored in the power database and then add the actual power consumption accumulated value from the start of the demand time period up to the current moment to the predicted value of the power consumption accumulated value from the current moment to the end of the demand time period, thereby calculating a predicted value of the power consumption accumulated value for this demand time period; and a second control unit arranged to control an appliance based on the predicted value calculated by the second predicted value calculating unit and a target value previously set.

In the case where each of the environmental conditions described above is specified by a time zone and an environmental condition other than the time zone, the first predicted value calculating unit described above that may be used include, for example, a unit arranged to extract the performance data that the time zone corresponds to this demand time period and that the environmental condition other than the time zone coincides with the current environmental condition, from the power database and then calculate the predicted value of the power consumption accumulated value for this demand time period based on the performance data thus extracted. Further, in this case, the second predicted value calculating unit described above that may be used include, for example, a unit comprising a unit arranged to calculate the actual power consumption accumulated value from the start of the demand time period up to the current moment; a unit arranged to extract the performance data that the time zone corresponds to a period from the current moment to the end of this demand time period and that the environmental condition other than the time zone coincides with the current environmental condition, from the power database and then calculate the predicted value of the power consumption accumulated value from the current moment to the end of the demand time period based on the performance data thus extracted; and a unit arranged to calculate the predicted value of the power consumption accumulated value for this demand time period by adding the actual power consumption accumulated value from the start of the demand time period up to the current moment to the predicted value of the power consumption accumulated value from the current moment to the end of the demand time period.

The first control unit described above that may be used include, for example, a unit arranged to, if the predicted value calculated by the first predicted value calculating unit exceeds the target value, select an appliance to stop its operation based on a difference between the predicted value and the target value and then stop the operation of the selected appliance. Further, the second control unit described above that may be used include, for example, a unit arranged to, if the predicted value calculated by the second predicted value calculating unit exceeds the target value, select an appliance to stop its operation based on the difference between the predicted value and the target value and then stop the operation of the selected appliance.

The first control unit described above that may be used includes, for example, a unit arrange to, if the predicted value calculated by the first predicted value calculating unit exceeds the target value, selects an appliance to stop its operation based on a difference between the predicted value and the target value, and then stops the operation of the selected appliance. Further, the second control unit described above that may be used includes, for example, a control unit comprising a unit arranged to, if the predicted value calculated by the second predicted value calculating unit exceeds the target value, select an appliance to be stopped based on the difference between the predicted value and the target value, and then stop the selected appliance; and a unit arranged to, if the predicted value calculated by the second predicted value calculating unit is equal to or less than the target value, select an appliance to be reset based on the difference between the predicted value and the target value, and then reset the selected appliance.

### BRIEF DESCRIPTION OF THE DRAWINGS

FIG. 1 is a block diagram showing power-consuming appliances provided in a store such as a supermarket, and a controller designed for centralized control of those appliances;

FIG. 2 is a diagram for schematically explaining each environmental condition specified by a time zone and an outside air temperature;

FIG. 3 is a diagram schematically showing a part of the contents of the power database 24;

FIG. 4 is a diagram schematically showing an example of the contents of the operation state database 25;

FIG. 5 is a diagram schematically showing an example of the contents of the stop/reset table 26;

FIG. 6 is a flow chart illustrating the steps of a demand control process executed by the controller 20;

FIG. 7 is a flow chart illustrating the steps of a prediction control process at the start of the demand time period in step S6 shown in FIG. 6;

FIG. 8 is a flow chart illustrating the steps of a prediction control process during the demand time period in step S9 shown in FIG. 6; and

FIG. 9 is a flow chart illustrating the steps of a prediction control process during the demand time period in step S9 shown in FIG. 6.

### DETAILED DESCRIPTION OF PREFERRED EMBODIMENTS

The embodiment of the present invention will be explained below with reference to the drawings.

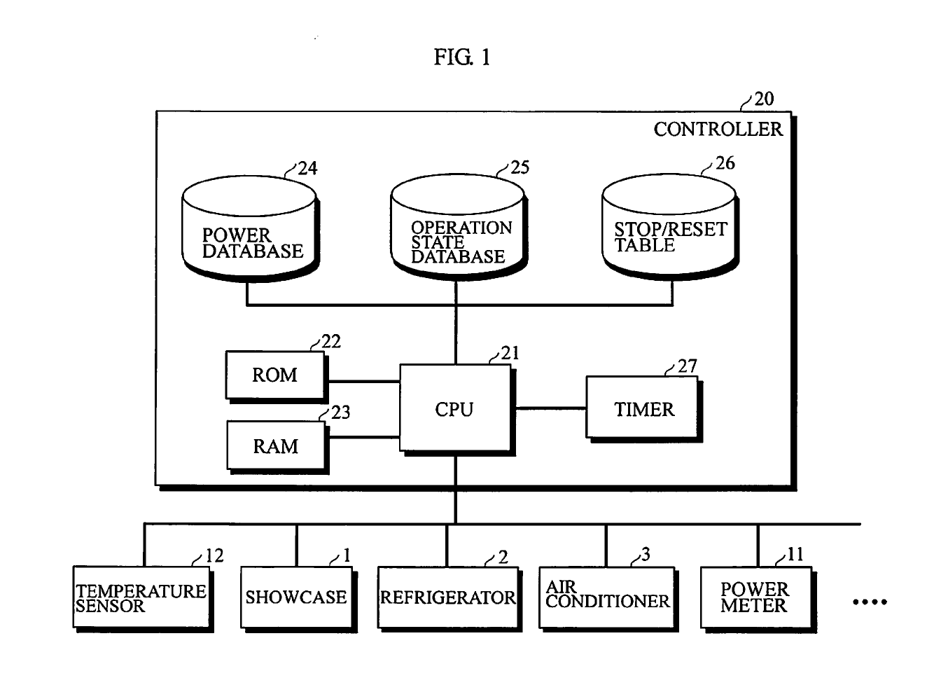

FIG. 1 shows power-consuming appliances provided in a store such as a supermarket, and a controller designed for centralized control of those appliances.

The controller 20 is connected to each of the power-consuming appliances arranged in the store, for example, a showcase 1, a refrigerator 2 and an air conditioner 3. The controller 20 is also connected to a power meter 11 that measures electric power consumption. The controller 20 is further connected to a temperature sensor 12 for measuring outside air temperature.

The controller 20 is provided with a CPU 21. The CPU 21 is connected to a ROM 22 that stores its program or the like, a RAM 23 that stores necessary data, a power database 24, an operation state database 25, a stop/reset table 26, and a timer 27. The power database 24, the operation state database 25, and the stop/reset table 26 are created in, for example, a rewritable nonvolatile memory.

In this embodiment, the term “power consumption accumulated value” refers to (a value obtained by dividing an accumulated value of a consumed electric power amount [W] in units of minutes by 30 [min]). A demand time period is 30 minutes.

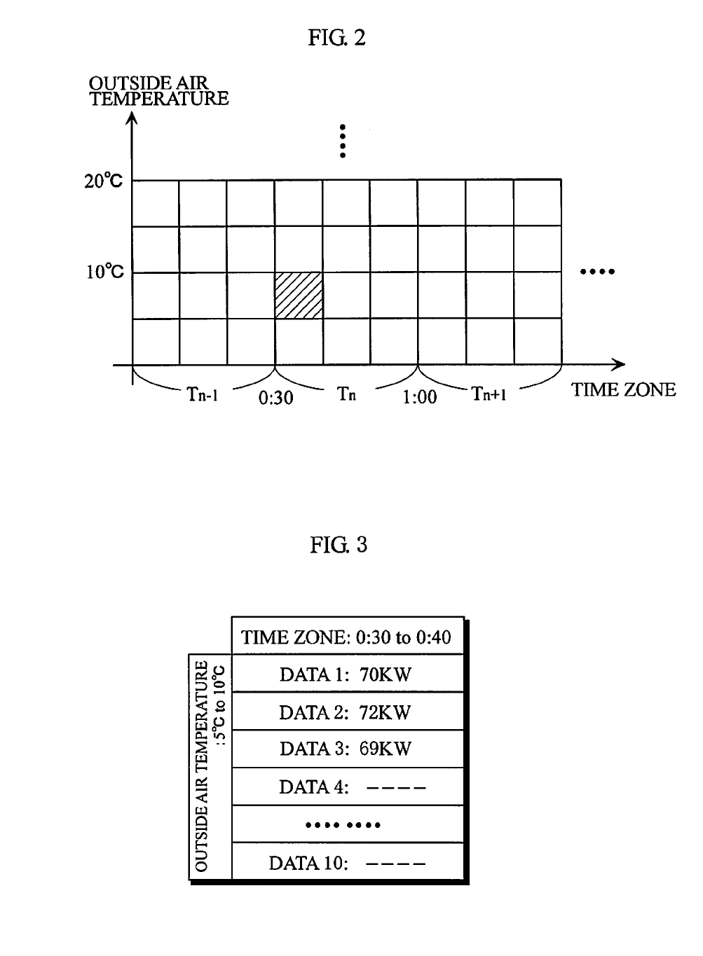

The power database 24 stores the power consumption accumulated value data (past performance data) of each environmental condition. In this example, as shown in FIG. 2, the environmental condition is specified by a time zone and an outside air temperature. The environmental condition is different for each square in FIG. 2. In the example of FIG. 2, the time zone and the outside air temperature are divided at intervals of 10 minutes and 5 degrees, respectively. The diagonally shaded square in FIG. 2 indicates the environmental condition where the time zone is from 0:30 to 0:40 and the outside air temperature is from 5° C. to 10° C. In FIG. 2, Tₙ₋₁, Tₙ and Tₙ₊₁ represent demand time periods.

FIG. 3 shows a part of the contents of the power database 24, indicating the power consumption accumulated value data stored for the environmental condition where the time zone is from 0:30 to 0:40 and the outside air temperature is from 5° C. to 10° C.

A maximum of ten performance data (power consumption accumulated value data) can be stored for each environmental condition. If the number of performance data exceeds ten for one environmental condition, the oldest data is deleted and the latest data is newly added. The performance data stored in the power database 24 is (a value obtained by dividing the accumulated value of the consumed electric power amount [W] in units of minutes in the applicable time zone (for 10 minutes) by 30 [min]).

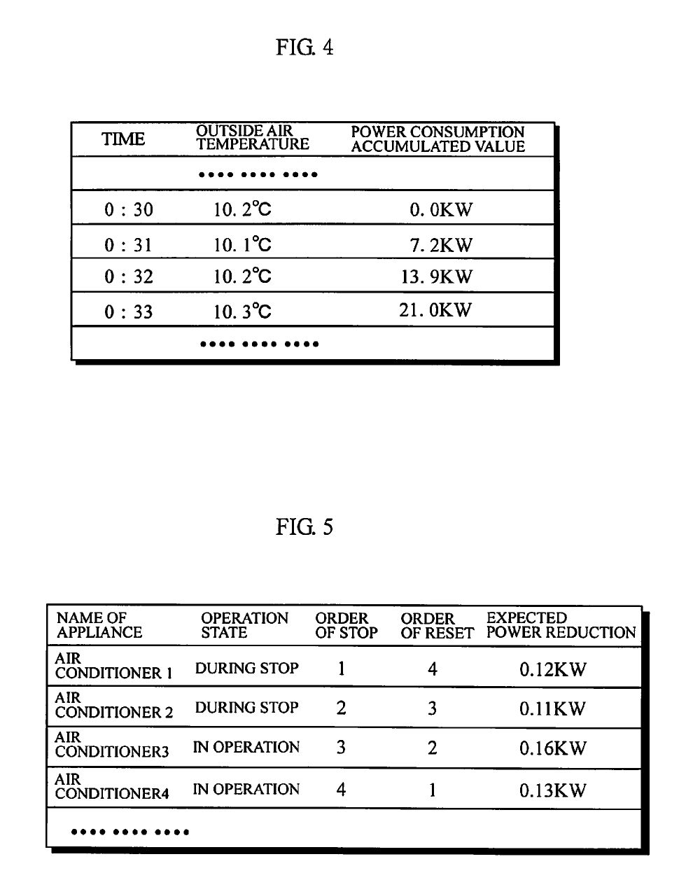

As shown in FIG. 4, the operation state database 25 stores an outside air temperature and a power consumption accumulated value from the start of the demand time period up to the current moment per time. The power consumption accumulated value stored in the operation state database 25 is (a value obtained by dividing the accumulated value of the consumed electric power amount [W] in units of minutes from the start of the demand time period up to the current moment by 30 [min]). At the start of the demand time period, the power consumption accumulated value is set to 0.

As shown in FIG. 5, the stop/reset table 26 stores name of appliance, operation state (in operation or during stop), order of stop, order of reset and expected power reduction, for each of the appliances capable of stopping.

The order of stop indicates the order of priority of stopping the operation. The order of reset indicates the order of priority of operating the appliance being stopped. The expected power reduction indicates the electric power consumption to be reduced when the operation of the appliance is stopped. The expected power reduction is expressed as a value obtained by dividing the consumed electric power amount [W] in units of minutes by 30 minutes. The expected power reduction amounts to, for example, an average of electric power consumption for the previous 30 minutes. Alternatively, if the electric power of each appliance is not measured, the expected power reduction may be calculated from the rated power of the appliance. The expected power reduction amounts to, for example, 50% of the rated power.

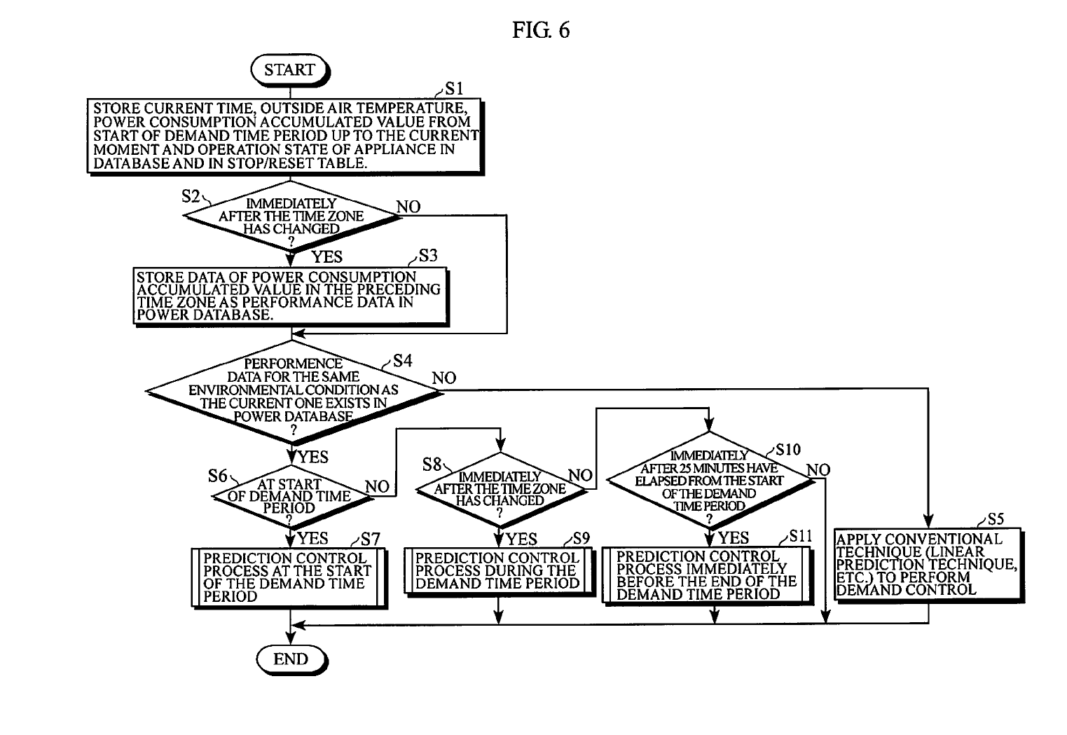

FIG. 6 shows the steps of a demand control process executed by the controller 20 (CPU 21).

This process is executed every given time, for example, every one minute.

First, the current time, the outside air temperature, and the power consumption accumulated value from the start of a demand time period up to the current moment are stored in the operation state database 25, and at the same time, the operation state of the appliance is stored in the stop/reset table 26 (step S1). The outside air temperature is acquired from the temperature sensor 12. The power consumption accumulated value from the start of the demand time period up to the current moment is calculated based on the consumed electric power acquired from the power meter 11 and the power consumption accumulated value stored in the operation state database 25.

Next, whether or not immediately after the change of the time zone that specifies the environmental condition is checked (step S2). Since the time zone is divided at intervals of 10 minutes, whether or not the time is immediately after M:00 (M is a natural number of 0 to 23), M:10, M:20, M:30, M:40 or M:50 is checked.

In the above step S2, if the time is judged as immediately after the change of the time zone that specifies the environmental condition, the power consumption accumulated value in the preceding time zone is stored in the power database 24 as the performance data for the environmental condition that coincides with the environmental condition in the preceding time zone (step S3). In this case, the power consumption accumulated value data in the preceding time zone is obtained from the power consumption accumulated value in the corresponding time zone stored in the operation state database 25. The outside air temperature is also obtained by averaging the data of the outside air temperature in the preceding time zone stored in the operation state database 25. After the process of step S3, the operation flow then proceeds to step S4.

In the above step S2, if the time is not judged as immediately after the change thereof, the operation flow then proceeds to step S4 without performing the process of step S3.

In step S4, whether or not the performance data for the same environmental condition as the current one (time zone and outside air temperature) exists in the power database 24 is checked. If such performance data does not exist, the demand control by the conventional technique is then performed (step S5). For example, a linear prediction technique or the like is applied to perform the demand control. Then, this process ends.

In the above step S4, if the performance data for the same environmental condition as the current one is judged to exist in the power database 24, whether or not it is at the start of a demand time period is checked (step S6). If it is judged to be at the start of a demand time period, the prediction control process at the start of the demand time period is then performed (step S7). The details of the prediction control process at the start of the demand time period will be described later. Then, this process ends.

In the above step S6, if it is judged not to be at the start time of a demand time period, whether or not immediately after the change of the time zone that specifies the environmental condition is checked (step S8). In this example, whether or not the time is immediately after 10 or 20 minutes have elapsed from the start of the demand time period is checked. If it is judged as immediately after the change of the time zone that specifies the environmental condition, the prediction control process during the demand time period is then performed (step S9). The details of the prediction control process during the demand time period will be described later. Then, this process ends.

In the above step S8, if the time is not judged as immediately after the change of the time zone that specifies the environmental condition, whether or not the time is immediately after 25 minutes have elapsed from the start of the demand time period is checked (step S10). If judged so, the prediction control process immediately before the end of the demand time period is then performed (step S9). The details of the prediction control process immediately before the end of the demand time period will be described later. Then, this process ends. In the above step S10, if the time is not judged as immediately after 25 minutes have elapsed from the start of the demand time period, this process then ends.

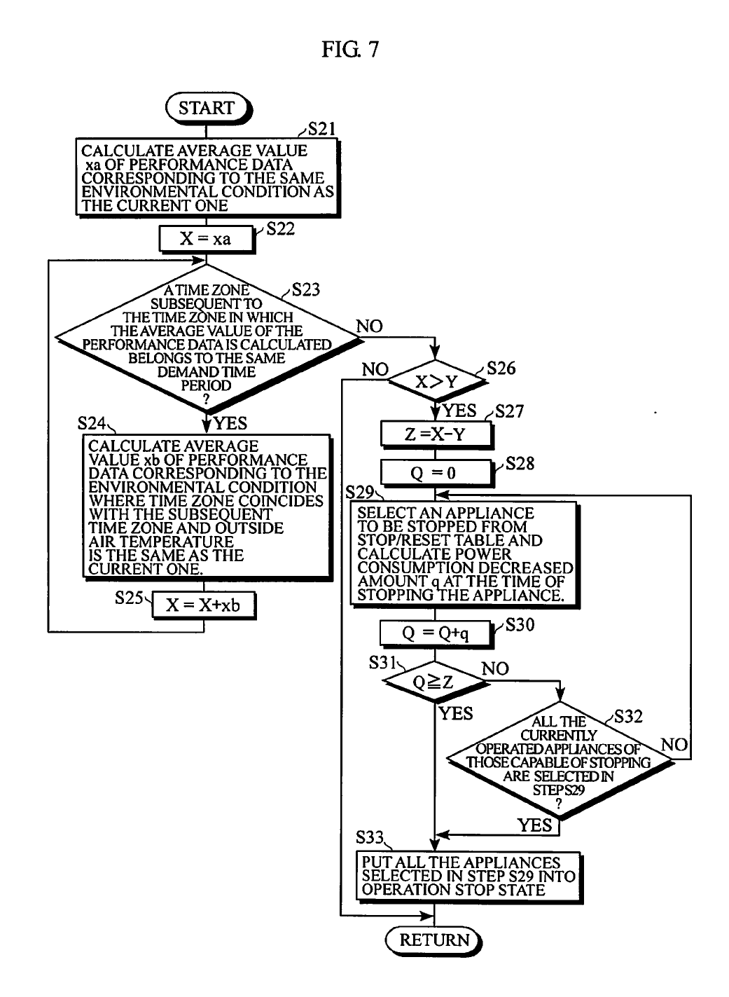

FIG. 7 shows the steps of a prediction control process at the start of the demand time period in step S7 shown in FIG. 6.

In the prediction control process at the start of the demand time period, a predicted value X of the power consumption accumulated value for this demand time period is calculated using the performance data stored in the power database 24, and the appliance is controlled based on the predicted value X thus calculated and the target value Y previously set.

First, the performance data (power consumption accumulated value data) corresponding to the same environmental condition as the current one (time zone and outside air temperature) is extracted from the power database 24, and an average value of the performance data thus extracted is calculated (step S21). Then, the calculated average value xa is set as the predicted value X (step S22).

Next, whether or not a time zone subsequent to the time zone in which the average value of the performance data has been calculated belongs to the same demand time period is checked (step S23). If belongs, the performance data (power consumption accumulated value data) corresponding to the environmental condition where a time zone coincides with the subsequent time zone and the outside air temperature is the same as the current one is extracted from the power database 24, and an average value xb of the performance data thus extracted is calculated (step S24). Then, the average value xb thus calculated is added to the predicted value X, and the obtained result is set as the predicted value X (step S25). Then, the operation flow returns to step S23.

In this example, since the demand time period is 30 minutes and the unit of the time zone is 10 minutes, the process of steps S23 to S25 is repeated twice. Therefore, the demand time period is equally divided into three, an average value of the performance data is calculated for each of the three time zones, and all the average values are added up to give the results as the predicted value X.

In the above step S23, if the time zone subsequent to the time zone in which the average value of the performance data has been calculated is judged not to belong to the same demand time period, whether or not the predicted value X finally obtained in the above step S25 exceeds the target value Y (X>Y) previously set is checked (step S26). If X<Y, the prediction control process at the start of this demand time period ends.

If X>Y, the difference therebetween, Z=(X−Y), is then calculated (step S27). The difference Z thus calculated is determined as a consumed electric power amount to be reduced (reduction target value). Further, a reduction predicted value Q of the electric power consumption is set to 0 (step S28).

Next, an appliance having the highest priority to stop is selected from among those currently operated from the stop/reset table 26, and a power consumption decreased amount q at the time when the operation of the selected appliance is stopped is calculated (step S29). The power consumption decreased amount q can be obtained by multiplying the expected power reduction stored in the stop/reset table 26 by the remaining period (in this example, 30 minutes) of the demand time period.

The power consumption decreased amount q calculated in step S29 is added to the reduction predicted value Q, and the added result is set as the reduction predicted value Q (step S30). Then, whether or not the reduction predicted value Q is equal to or more than the reduction target value Z (Q≧Z) is checked (step S31).

If the reduction predicted value Q is less than the reduction target value Z (Q<Z), whether or not all the currently operated appliances of those capable of stopping stored in the stop/reset table 26 are selected as appliances targeted for calculation of the power consumption decreased amount q is checked (step S32).

If not selected, the operation flow then returns to step S29. Then, an appliance having the highest priority to stop is selected from among those currently operated except the one already selected in step S29, and the power consumption decreased amount q at the time when the operation of the selected appliance is stopped is calculated. The processes of step S30 and subsequent steps are then performed.

In the above step S31, if the reduction predicted value Q is judged to be equal to or more than the reduction target value Z (Q≧Z), all the appliances selected in the above step S29 are put into an operation stop state (step S33). The prediction control process at the start of this demand time period then ends.

In the above step S32, if judged to be selected, all the appliances selected in the above step S29 are put into the operation stop state (step S33). The prediction control process at the start of this demand time period then ends.

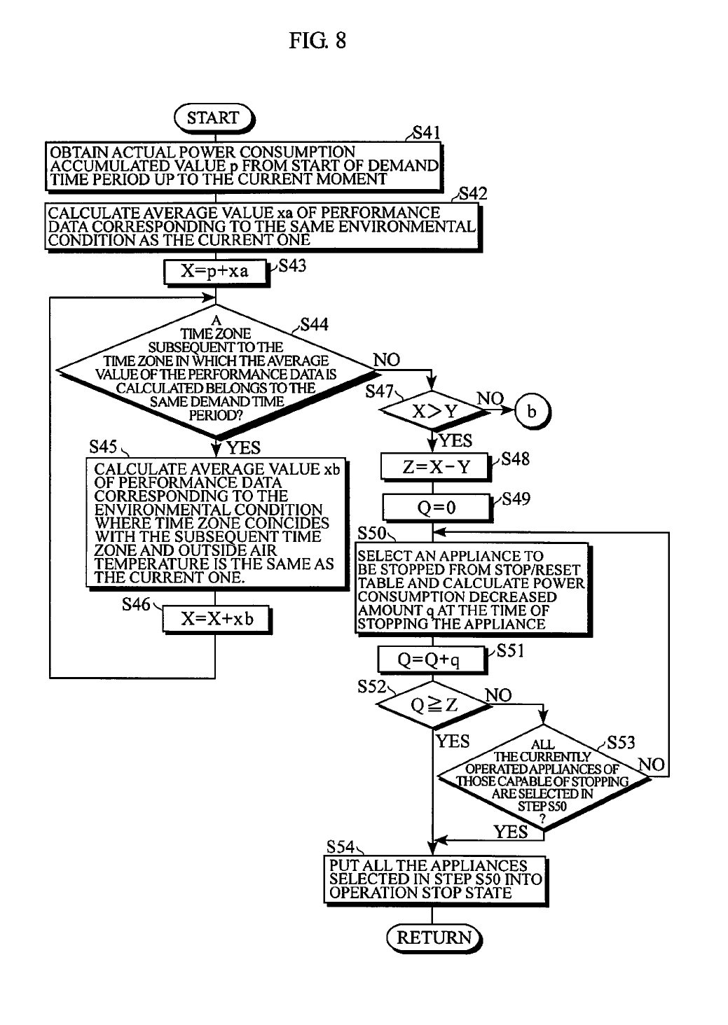

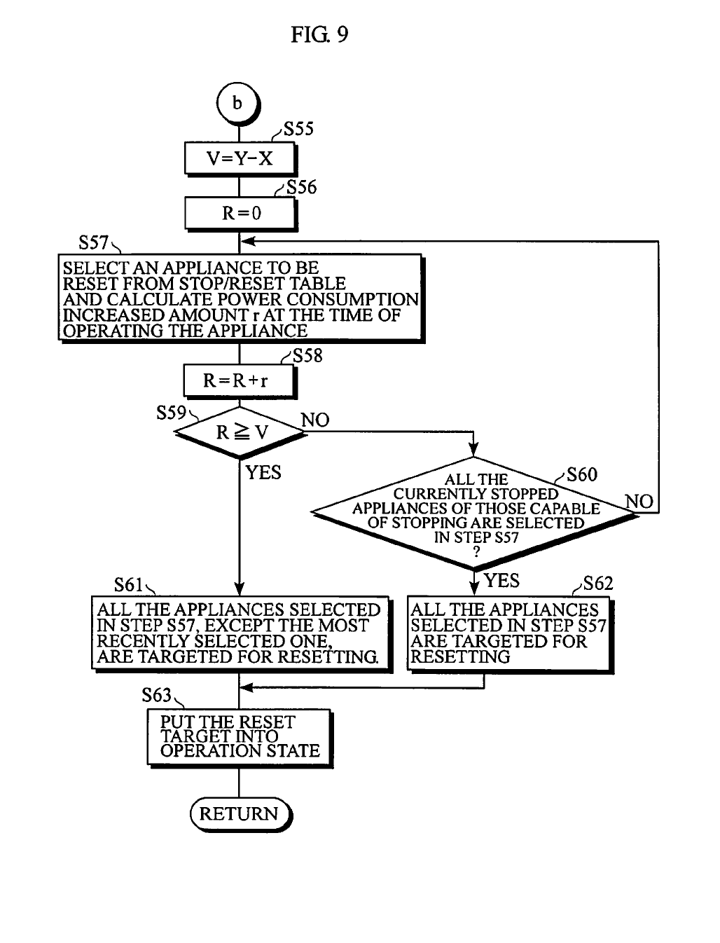

FIGS. 8 and 9 show a prediction control process during the demand time period in step S9 shown in FIG. 6.

In the prediction control process during the demand time period, the actual power consumption accumulated value from the start of the demand time period up to the current moment is obtained. At the same time, the predicted value of the power consumption accumulated value from the current moment to the end of the demand time period is obtained from the performance data stored in the power database 24 for every environmental condition, the added result thereof is set as a predicted value X of the power consumption accumulated value for this demand time period, and the appliance is controlled based on the predicted value X and the target value Y previously set.

First, the actual power consumption accumulated value p from the start of the demand time period up to the current moment is obtained based on the data stored in the operation state database 25 (step S41).

Next, the performance data (power consumption accumulated value data) corresponding to the same environmental condition as the current one (time zone and outside air temperature) is extracted from the power database 24, and an average value of the performance data thus extracted is calculated (step S42).

The power consumption accumulated value p obtained in step S41 is added to the average value xa calculated in step S42, and the added result is set as the predicted value X (step S43).

Next, whether or not a time zone subsequent to the time zone in which the average value of the performance data has been calculated belongs to the same demand time period is checked (step S44). If belongs, the performance data (power consumption accumulated value data) corresponding to the environmental condition where a time zone coincides with the subsequent time zone and the outside air temperature is the same as the current one is extracted from the power database 24, and an average value xb of the performance data thus extracted is calculated (step S45). Then, the average value xb thus calculated is added to the predicted value X, and the obtained result is set as the predicted value X (step S46). Then, the operation flow returns to step S44.

In the case where the time is immediately after 10 minutes have elapsed from the start of the demand time period, the actual power consumption accumulated value p from the start of the demand time period up to the current moment is calculated in step S41, the average value xa of the performance data in the time zone from 10 minutes after the start of the demand time period up to 20 minutes therefrom is calculated in step S42, and the operation of X=p+xa is performed in step S43. Then, the first step S44 results in YES, the average value xb of the performance data in the time zone from 20 minutes after the start of the demand time period up to 30 minutes therefrom is calculated in step S45, and the operation of X=X+xb is performed in step S46. Then, the second step S44 results in NO.

In the case where the time is immediately after 20 minutes have elapsed from the start of the demand time period, the actual power consumption accumulated value p from the start of the demand time period up to the current moment is calculated in step S41, the average value xa of the performance data in the time zone from 20 minutes after the start of the demand time period up to 30 minutes therefrom is calculated in step S42, and the operation of X=p+xa is performed in step S43. Then, the first step S44 results in NO.

In the above step S44, if the time zone subsequent to the time zone in which the average value of the performance data has been calculated is judged not to belong to the same demand time period, step S44 results in NO and then proceeds to step S47.

In step S47, whether or not the predicted value X exceeds the target value Y (X>Y) previously set is checked.

If X>Y, the same process as that in steps S27 to S33 of FIG. 7 is performed. That is, the difference therebetween, Z=(X−Y), is calculated (step S48). The difference Z thus calculated is determined as a consumed electric power amount to be reduced (reduction target value). Further, a reduction predicted value Q of the electric power consumption is set to 0 (step S49).

Next, an appliance having the highest priority to stop is selected from among those currently operated from the stop/reset table 26, and a power consumption decreased amount q at the time when the operation of the selected appliance is stopped is calculated (step S50). The power consumption decreased amount q can be obtained by multiplying the expected power reduction stored in the stop/reset table 26 by the remaining period (in this example, either 20 minutes or 10 minutes) of the demand time period.

The power consumption decreased amount q calculated in step S50 is added to the reduction predicted value Q, and the added result is set as the reduction predicted value Q (step S51). Then, whether or not the reduction predicted value Q is equal to or more than the reduction target value Z (Q≧Z) is checked (step S52).

If the reduction predicted value Q is less than the reduction target value Z (Q<Z), whether or not all the currently operated appliances of those capable of stopping stored in the stop/reset table 26 are selected as appliances targeted for calculation of the power consumption decreased amount q is checked (step S53).

If not selected, the operation flow then returns to step S50. Then, an appliance having the highest priority to stop is selected from among those currently operated except the one already selected in step S50, and the power consumption decreased amount q at the time of when the operation of the selected appliance is stopped is calculated. The processes of step S51 and subsequent steps are then performed.

In the above step S52, if the reduction predicted value Q is judged to be equal to or more than the reduction target value Z (Q≧Z), all the appliances selected in the above step S50 are put into an operation stop state (step S54). The prediction control process during this demand time period then ends.

In the above step S53, if judged to be selected, all the appliances selected in the above step S50 are put into the operation stop state (step S54). The prediction control process during this demand time period then ends.

In the above step S47, if X≦Y, the difference therebetween, V=(Y−X), is calculated (step S55). The difference V thus calculated is determined as a consumed electric power amount to be reset (reset target value). Further, a reset predicted value R of the electric power consumption is set to 0 (step S56).

Next, an appliance having the highest priority to reset is selected from among those currently stopped from the stop/reset table 26, and a power consumption increased amount r at the time of operating the selected appliance is calculated (step S57). The power consumption increased amount r can be obtained by multiplying the expected power reduction stored in the stop/reset table 26 by the remaining period (in this example, either 20 minutes or 10 minutes) of the demand time period.

The power consumption increased amount r calculated in step S57 is added to the reset predicted value R, and the added result is set as the reset predicted value R (step S58). Then, whether or not the reset predicted value R is equal to or more than the reset target value V (R≧V) is checked (step S59).

If the reset predicted value R is less than the reset target value V (R<V), whether or not all the currently stopped appliances of those capable of stopping stored in the stop/reset table 26 are selected as appliances targeted for calculation of the power consumption increased amount r is checked (step S60).

If not selected, the operation flow then returns to step S57. Then, an appliance having the highest priority to reset is selected from among those currently stopped except the one already selected in step S57, and the power consumption increased amount r at the time of operating the selected appliance is calculated. The processes of step S58 and subsequent steps are then performed.

In the above step S59, if the reset predicted value R is judged to be equal to or more than the reset target value V (R≧V), all the appliances selected in the above step S57 except the most recently selected one, are targeted for resetting (step S61). The operation flow then proceeds to step S63.

In the above step S60, if judged to be selected, all the appliances selected in above step 57 are targeted for resetting(step S62). The operation flow then proceeds to step S63.

In step S63, the appliances targeted for resetting are put into an operation state. The prediction control process during this demand time period then ends.

Next, the prediction control process immediately before the end of the demand time period in step S11 of FIG. 6 will be explained.

The prediction control process immediately before the end of the demand time period is substantially the same as that during the demand time period. The prediction control process immediately before the end of the demand time period is different from that during the demand time period only in the method of calculating the predicted value X (process of steps S41 to S46 of FIG. 8). Therefore, such method will be explained.

First, the actual power consumption accumulated value p from the start of the demand time period up to the current moment (up to 25 minutes after the start of the demand time period) is calculated based on the data stored in the operation state database 25. Next, the predicted value of the power consumption accumulated value from the current moment (25 minutes after the start of the demand time period) to the end of the demand time period is calculated from the performance data in the power database 24.

Specifically, the performance data (power consumption accumulated value data) corresponding to the same environmental condition as the current one (time zone and outside air temperature) is extracted from the power database 24. Each of the performance data thus extracted therefrom is a power consumption accumulated value for 10 minutes. However, it is necessary here to calculate a power consumption accumulated value for 5 minutes. Therefore, one half of the average value of the performance data thus extracted from the power database 24 is set as a predicted value x of the power consumption accumulated value from the current moment to the end of the demand time period. Alternatively, one half of the maximum value of the performance data thus extracted may be set as the predicted value x of the power consumption accumulated value from the current moment to the end of the demand time period.

The actual power consumption accumulated value p from the start of the demand time period up to the current moment (up to 25 minutes after the start of the demand time period) is then added to the predicted value x of the power consumption accumulated value from the current moment to the end of the demand time period, to give a predicted value X.

In the above embodiment, the environmental condition is specified by the time zone and the outside air temperature and may be specified by other elements, for example, a time zone and a temperature (or humidity) in the store. The operation state of a showcase can also be applied as an environmental condition. The showcase is provided with a refrigerant pipe which allows flowing of a refrigerant for cooling, and the temperature in the showcase is adjusted by opening and closing a solenoid valve attached to the refrigerant pipe to adjust the flow rate of the refrigerant. A larger load on the showcase requires a sufficient amount of refrigerant, resulting in longer time to leave the solenoid valve open. Thus, an opening ratio of the solenoid valve is specified as an environmental condition, so that the electric power data can be learned depending on the load of the showcase. Further, the showcase periodically performs defrosting operation in order to prevent frost from forming thereon. Since the electric power consumption during the defrosting operation is different from that during normal operation, it is also effective to add the number of showcases under the defrosting operation to the environmental condition.

In the above embodiment, the order of stop and the order of reset are fixed. The order of stop may, however, be changed so that when an appliance is once stopped and then reset by the demand control, the order of stopping the appliance results in the largest value.

According to the above embodiment, the performance data used for calculation of the predicted value is stored by environmental condition. This reduces variations in the performance data to give a reliable predicted value. Most of the electric power in the store is consumed by cooling appliances, such as a showcase and a freezer, and lighting appliances. Among these appliances, lighting appliances are believed to have small variations in the electric power consumption due to the environmental condition, whereas cooling appliances are believed to have large variations therein due to the environmental condition. Thus, since the factor causing the variations in the electric power consumed by the cooling appliances is set as an element of the environmental condition, a reliable predicted value is obtained. As a result of this, it can be avoided as possible that the actual power consumption accumulated value for a demand time period exceeds the contracted power amount.

According to the present invention, it can be avoided as possible that the actual power consumption accumulated value for a demand time period exceeds the contracted power amount.

1. A demand control device applied in a facility provided with a plurality of power-consuming appliances, the demand control device comprising:
a storing unit arranged to store performance data of a power consumption accumulated value by environmental condition in a power database;
a predicted value calculating unit arranged to, at a start of a demand time period, calculate a predicted value of the power consumption accumulated value for the demand time period based on the performance data stored in the power database; and
a control unit arranged to control an appliance based on the predicted value calculated by the predicted value calculating unit and a target value previously set,
wherein each of the environmental conditions is specified by a time zone and an environmental condition other than the time zone, and the predicted value calculating unit extracts the performance data that the time zone corresponds to this demand time period and that the environmental condition other than the time zone coincides with the current environmental condition, from the power database and then calculates the predicted value of the power consumption accumulated value for this demand time period based on the performance data thus extracted.

2. The demand control device according to claim 1, wherein the control unit, if the predicted value calculated by the predicted value calculating unit exceeds the target value, selects an appliance to stop its operation based on a difference between the predicted value and the target value, and then stops the operation of the selected appliance.

3. A demand control device applied in a facility provided with a plurality of power-consuming appliances, the demand control device comprising:
a storing unit arranged to store performance data of a power consumption accumulated value by environmental condition in a power database;
a predicted value calculating unit arranged to, during a demand time period, calculate an actual power consumption accumulated value from a start of the demand time period up to the current moment, and at the same time, calculate a predicted value of the power consumption accumulated value from the current moment to an end of the demand time period based on the performance data stored in the power database and then add the actual power consumption accumulated value from the start of the demand time period up to the current moment to the predicted value of the power consumption accumulated value from the current moment to the end of the demand time period, thereby calculating a predicted value of the power consumption accumulated value for this demand time period; and
a control unit arranged to control an appliance based on the predicted value calculated by the predicted value calculating unit and a target value previously set,
wherein each of the environmental conditions is specified by a time zone and an environmental condition other than the time zone, and the predicted value calculating unit comprises a unit arranged to calculate the actual power consumption accumulated value from the start of the demand time period up to the current moment; a unit arranged to extract the performance data that the time zone corresponds to a period from the current moment to the end of this demand time period and that the environmental condition other than the time zone coincides with the current environmental condition, from the power database and then calculate the predicted value of the power consumption accumulated value from the current moment to the end of the demand time period based on the performance data thus extracted; and a unit arranged to calculate the predicted value of the power consumption accumulated value for this demand time period by adding the actual power consumption accumulated value from the start of the demand time period up to the current moment to the predicted value of the power consumption accumulated value from the current moment to the end of the demand time period.

4. The demand control device according to claim 3, wherein the control unit, if the predicted value calculated by the predicted value calculating unit exceeds the target value, selects an appliance to stop its operation based on a difference between the predicted value and the target value, and then stops the operation of the selected appliance.

5. The demand control device according to claim 3, wherein
the control unit comprises
a unit arranged to, if the predicted value calculated by the predicted value calculating unit exceeds the target value, select an appliance to be stopped based on a difference between the predicted value and the target value, and then stop the selected appliance; and
a unit arranged to, if the predicted value calculated by the predicted value calculating unit is equal to or less than the target value, select an appliance to be reset based on the difference between the predicted value and the target value, and then reset the selected appliance.

6. A demand control device applied in a facility provided with a plurality of power-consuming appliances, the demand control device comprising:
a storing unit arranged to store performance data of a power consumption accumulated value by environmental condition in a power database;
a first predicted value calculating unit arranged to, at a start of a demand time period, calculate a predicted value of the power consumption accumulated value for this demand time period based on the performance data stored in the power database;
a first control unit arranged to control an appliance based on the predicted value calculated by the first predicted value calculating unit and a target value previously set;
a second predicted value calculating unit arranged to, during the demand time period, calculate an actual power consumption accumulated value from the start of the demand time period up to the current moment, and at the same time, calculate a predicted value of the power consumption accumulated value from the current moment to an end of the demand time period based on the performance data stored in the power database and then add the actual power consumption accumulated value from the start of the demand time period up to the current moment to the predicted value of the power consumption accumulated value from the current moment to the end of the demand time period, thereby calculating a predicted value of the power consumption accumulated value for this demand time period; and
a second control unit arranged to control an appliance based on the predicted value calculated by the second predicted value calculating unit and a target value previously set.

7. The demand control device according to claim 6, wherein
each of the environmental conditions is specified by a time zone and an environmental condition other than the time zone,
the first predicted value calculating unit extracts the performance data that the time zone corresponds to this demand time period and that the environmental condition other than the time zone coincides with the current environmental condition, from the power database and then calculates the predicted value of the power consumption accumulated value for this demand time period based on the performance data thus extracted, and
the second predicted value calculating unit comprises a unit arranged to calculate the actual power consumption accumulated value from the start of the demand time period up to the current moment; a unit arranged to extract the performance data that the time zone corresponds to a period from the current moment to the end of this demand time period and that the environmental condition other than the time zone coincides with the current environmental condition, from the power database and then calculate the predicted value of the power consumption accumulated value from the current moment to the end of the demand time period based on the performance data thus extracted; and a unit arranged to calculate the predicted value of the power consumption accumulated value for this demand time period by adding the actual power consumption accumulated value from the start of the demand time period up to the current moment to the predicted value of the power consumption accumulated value from the current moment to the end of the demand time period.

8. The demand control device according to claim 6, wherein
the first control unit, if the predicted value calculated by the first predicted value calculating unit exceeds the target value, selects an appliance to stop its operation based on a difference between the predicted value and the target value, and then stops the operation of the selected appliance, and
the second control unit, if the predicted value calculated by the second predicted value calculating unit exceeds the target value, selects an appliance to stop its operation based on the difference between the predicted value and the target value, and then stops the operation of the selected appliance.

9. The demand control device according to claim 6, wherein
the first control unit, if the predicted value calculated by the first predicted value calculating unit exceeds the target value, selects an appliance to stop its operation based on a difference between the predicted value and the target value, and then stops the operation of the selected appliance, and
the second control unit comprises a unit arranged to, if the predicted value calculated by the second predicted value calculating unit exceeds the target value, select an appliance to be stopped based on the difference between the predicted value and the target value, and then stop the selected appliance; and a unit arranged to, if the predicted value calculated by the second predicted value calculating unit is equal to or less than the target value, select an appliance to be reset based on the difference between the predicted value and the target value, and then reset the selected appliance.
